(19) United States
(12) Patent Application Publication
(10) Pub. No.: US 2006/0085337 A1
(43) Pub. Date: Apr. 20, 2006

(54) Method and system for using payment cards as a payment option within an online bill payment and presentment solution

(76) Inventors: Cathleen M. Conforti, Howell, NJ (US); Thomas A. Carey, Riverdale, NY (US); Dennis H. Sullivan JR., Chicago, IL (US); Thomas D. Smith, St. Charles, MO (US)

Correspondence Address: BAKER & BOTTS, 30 ROCKEFELLER PLAZA, NEW YORK, NY, 10112, US

(21) Appl. No.: 11/148,939

(22) Filed: Jun. 9, 2005

Related U.S. Application Data
(63) Continuation of application No. 10/949,564, filed on Sep. 24, 2004, now abandoned.
(60) Provisional application No. 60/506,370, filed on Sep. 26, 2003.

(51) Int. Cl. G06Q 40/00

(52) U.S. Cl. 705/40

(57) ABSTRACT

An exchange hub is provided that is programmed to receive by way of an open, standardized, secure messaging protocol, a payment card transaction request from a consumer's CSP. A consumer transmits to an EBPP system a request to pay a bill electronically using a payment card. The consumer's payment card transaction request is submitted to the consumer's CSP. The payment card transaction request is then submitted to the exchange hub of the EBPP system. The exchange hub parses the payment card transaction request, and generates a payment message to the biller's acquiring bank (the “acquirer”). The acquirer generates an authorization request message and transmits it to the issuer of the consumer's payment card. The issuer either approves or denies the consumer's payment card transaction request, and notifies the acquirer. The acquirer then, in turn, submits and appropriate approval or denial response to the exchange hub of the EBPP system. If the transaction is approved by the acquirer, the acquirer settles with the biller, and the consumer pays the payment card issuer when the consumer is eventually billed for the payment card transaction.

### SPECIFICATION

This application claims priority to a United States Provisional Application entitled “Method and System For Using Payment Cards as a Payment Option Within an Online Bill Payment and Presentment Solution,” Ser. No. 60/506,370, which was filed on Sep. 26, 2003, and is incorporated by reference into the present application.

### FIELD OF THE INVENTION

The present invention relates generally to a method and system for electronic bill payment and presentment over a communications network, and more particularly to a method and system for enabling consumers to use payment cards and other non-cash vehicles to pay their bills in an electronic bill payment and presentation system.

### BACKGROUND OF THE INVENTION

The process of presenting and paying bills online instead of using traditional paper-based methods is known as electronic bill payment and presentment (“EBPP”). EBPP is a fast growing segment of the e-commerce market. Increasingly, consumers are turning to EBPP systems to pay their bills electronically, preferring EBPP to the laborious and time consuming chore of writing checks, sealing envelopes, purchasing stamps, and walking their bill payment to the mailbox.

Currently, there are two basic EBPP models: the direct model, and the consolidator model. In the direct model, a biller presents its electronic bill to a consumer by way of the biller's own Web site. The consumer must visit the biller's Web site to view the bill, and then must pay it at the biller's Web site. The biller's Web site typically offers the consumer a number of payment options, including directly debiting the consumer's bank account, or using a payment card such as a credit card, debit card, pre-paid card, or other non-cash payment account vehicle.

The direct model has the disadvantage that it requires the consumer to individually visit a different Web site for each electronic bill that the consumer wishes to electronically pay. The consolidator EBPP model attempts to overcome this disadvantage by consolidating for the consumer multiple bills from multiple billers in aggregate for presentment on a single Web site, such as the consumer's online banking web site. In the consolidator model, the consumer need only visit a single Web site to electronically view and pay his bills. This consolidation is typically accomplished by using a centralized switching facility or “exchange hub,” that routes aggregated electronic bills to a customer service provider (“CSP”) for presentment to consumers who are enrolled with the CSP. The exchange hub also routes electronic payments of these bills by consumers to the appropriate biller service provider (“BSP”), which serves as the billing agent for the biller.

Currently, however, the consolidator EBPP model has the disadvantage that payment cards, such as credit cards, debit cards, prepaid cards, or other non-cash payment vehicles, are not available to consumers as a payment option.

### SUMMARY OF THE INVENTION

It is an object of the present invention to provide consumers with the ability to use payment cards to electronically pay electronic bills in an EBPP system.

In accordance with the present invention, an exchange hub is provided that is programmed to receive, by way of an open, standardized, secure messaging protocol, a payment card transaction request from a consumer's CSP. In an exemplary embodiment of the present invention, the consumer transmits to an EBPP system a request to pay a bill electronically using a payment card. The consumer's payment card transaction request is submitted to the consumer's CSP, along with all the details necessary for authorization processing (such as card-holder name, payment card account number, expiration date, etc.). The payment card transaction request may then be batched by the CSP and submitted to the exchange hub (e.g., MasterCard's Remote Payment and Presentment System (“RPPS”)) of the EBPP system. The exchange hub may then parse the payment card transaction request, and generate a payment message to the biller's acquiring bank (the “acquirer”).

From here on, the conventional process of payment card authorization is utilized. The acquirer generates an authorization request message and transmits it to the issuer of the consumer's payment card. The issuer either approves or denies the consumer's payment card transaction request, and notifies the acquirer. The acquirer then, in turn, submits and appropriate approval or denial response to the exchange hub of the EBPP system. If the transaction is approved by the acquirer, the acquirer settles with the biller, and provides remittance data to the biller. The consumer pays the payment card issuer when the consumer is eventually billed for the payment card transaction.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a block diagram depicting an EBPP system with a payment card payment option, in accordance with an exemplary embodiment of the present invention;

FIG. 2 is a block diagram depicting the components of the EBPP system and a payment card authorization system in accordance with an exemplary embodiment of the present invention; and

FIG. 3 is a flow chart depicting a process by which a consumer pays an electronic bill in the EBPP system in accordance with an exemplary embodiment of the present invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF THE INVENTION

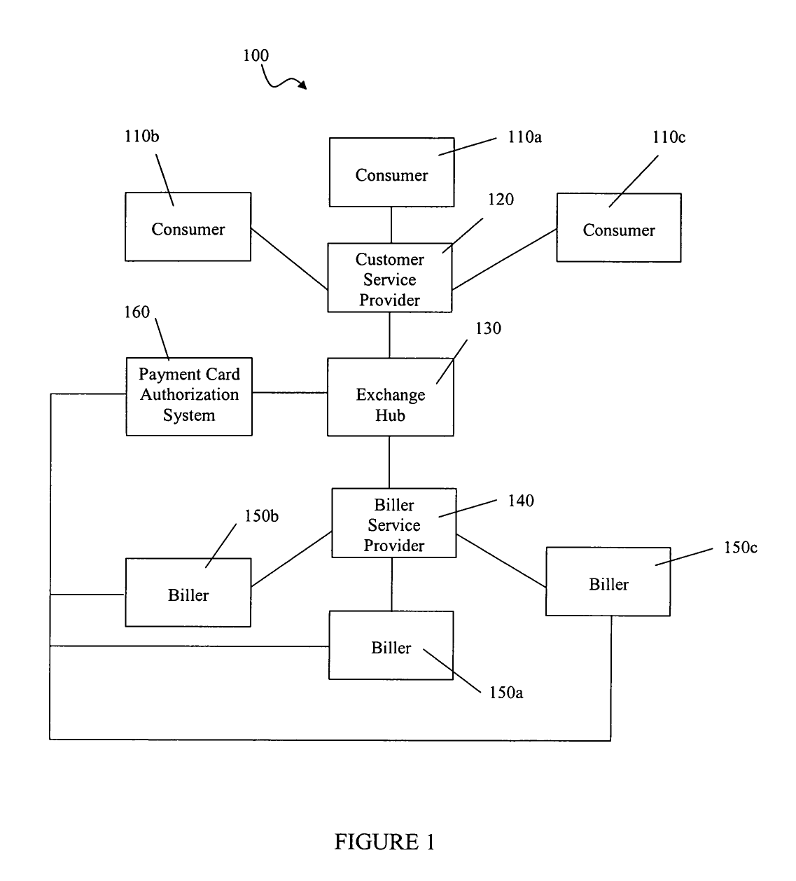

FIG. 1 is a block diagram depicting the overall relationship of the main components in an EBPP system 100, in accordance with an exemplary embodiment of the present invention. The components of the EBPP system 100 exchange data via a conventional computer network. The computer network may be, for example, the Internet, in which case the components may communicate using World Wide Web protocols such as HTTP and HTTPS. However those of ordinary skill in the art will appreciate that the various components of EBPP system 100 may alternatively communicate via virtual private networks (VPN), local area networks (LAN), private wide area networks (WAN), or any other conventional data communications network using any standard networking protocol.

The EBPP system 100 enables one or more consumers 110a-c (three are shown) to use a computer to electronically view, and pay, bills for goods or services that are electronically presented to them by one or more billers 150a-c (three are shown). For the purposes of this application, “computer” shall be deemed to include any computer capable of networked data communication with other components of the EBPP system 100. Thus, “computer” includes not just desktop PCs, but laptop computers, server computers, handheld computers, personal digital assistants (PDAs), and cellular telephones. Preferably, the computers used by the consumers 110a-c are programmed with conventional Web browsers, which provide the graphical user interface through which the consumers 110a-c may view and pay their bills.

The customer service provider component 120 (“CSP”) is preferably a bank with which the consumers 110a-c have opened a financial account, but may also include non-financial third party bill processors with which consumers 110a-c have enrolled for EBPP bill payment. The CSP 120 provides the consumers 110a-c with the user interface for interacting with the EBPP system 100. The CSP 120 delivers to the consumers' 110a-c computers electronic billing data from the billers 150a-c, which the consumers 110a-c may view using a Web browser. Via the interface provided by the CSP 120, the CSP 120 may also receive from consumers 110a-c electronic bill payment requests (which include payment data) from the consumers 110a-c. The electronic bill payment options made available to the consumers 110a-c by their CSP 120 preferably include requests to directly debit the consumers' 110a-c banks accounts, as well as requests to charge a payment card account.

As used in this application, a payment card may be any non-cash payment account vehicle—such as credit, debit, and prepaid cards—that may be used to provide payment for goods and/or services. These payment cards may be issued by individual card companies or by financial institutions that are members of a payment association (such as MasterCard® International). As used in this application, the term payment card includes not only physical payment cards, but also virtual payment cards in which the payment account information is stored in digital or electronic form, such as in a digital wallet.

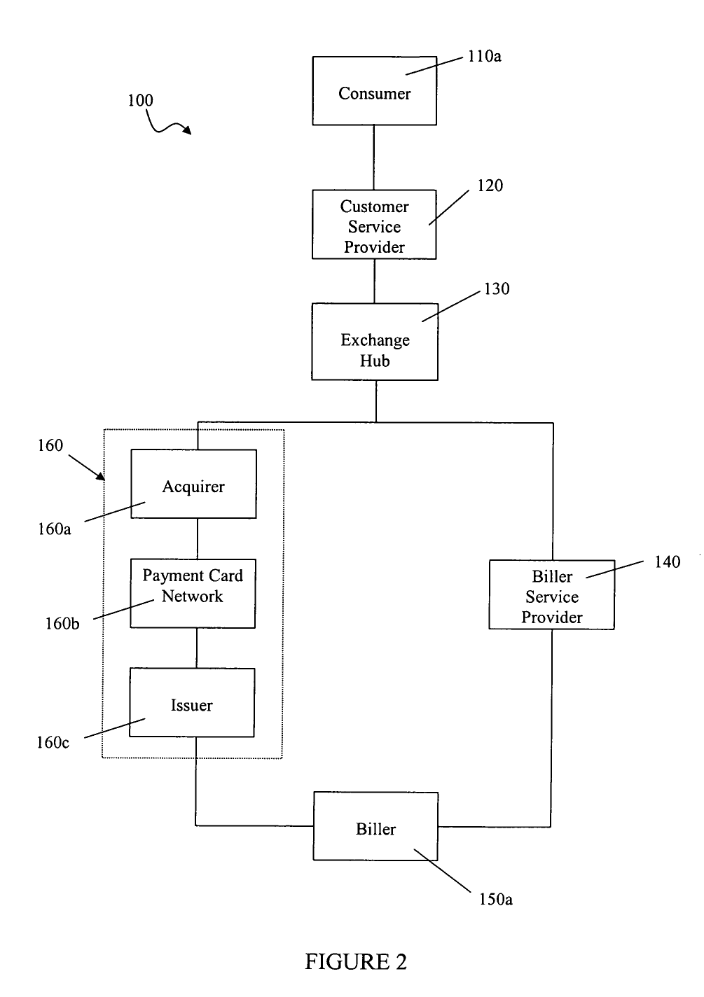

The biller service provider 140 (“BSP”) acts as the billing agent for the billers 150a-c in the EBPP system. The BSP 140 receives billing data from the billers 150a-c and transmits the billing data to the CSP 120 for presentment to the consumers 110a-c. The BSP 140 also receives payment data from the CSP 120, and credits the billers' 150a-c accounts to settle the electronic bills. In an alternative body of the present invention, the acquirer 160 (discussed below in connection with FIG. 2) may play the role of the BSP.

The CSP 120 and BSP 140 communicate with each other by way of an exchange hub 130, such as MasterCard's Remote Payment and Presentment System (“RPPS”), which is described in United States Patent Application Publication No. 2002/0049671A1 (incorporated herein by reference). The exchange hub 130, routes electronic bills from the BSP 140 to the CSP 120, and routes electronic bill payments from the CSP 120 to the BSP 140. In accordance with the present invention, the exchange hub 130 also routes payment card bill payment requests to a payment card authorization system 160 for payment authorization, processing, and settlement in accordance with conventional payment card processing protocols.

Messages received by the exchange hub 130 are preferably parsed and its contents validated. Routing information and pertinent log data are preferably captured by the exchange hub 130. The exchange hub 130 then rebundles the message, and delivers it to the intended recipient (either the CSP 120, the BSP 140, or the payment card authorization network 160), preferably over secure lines.

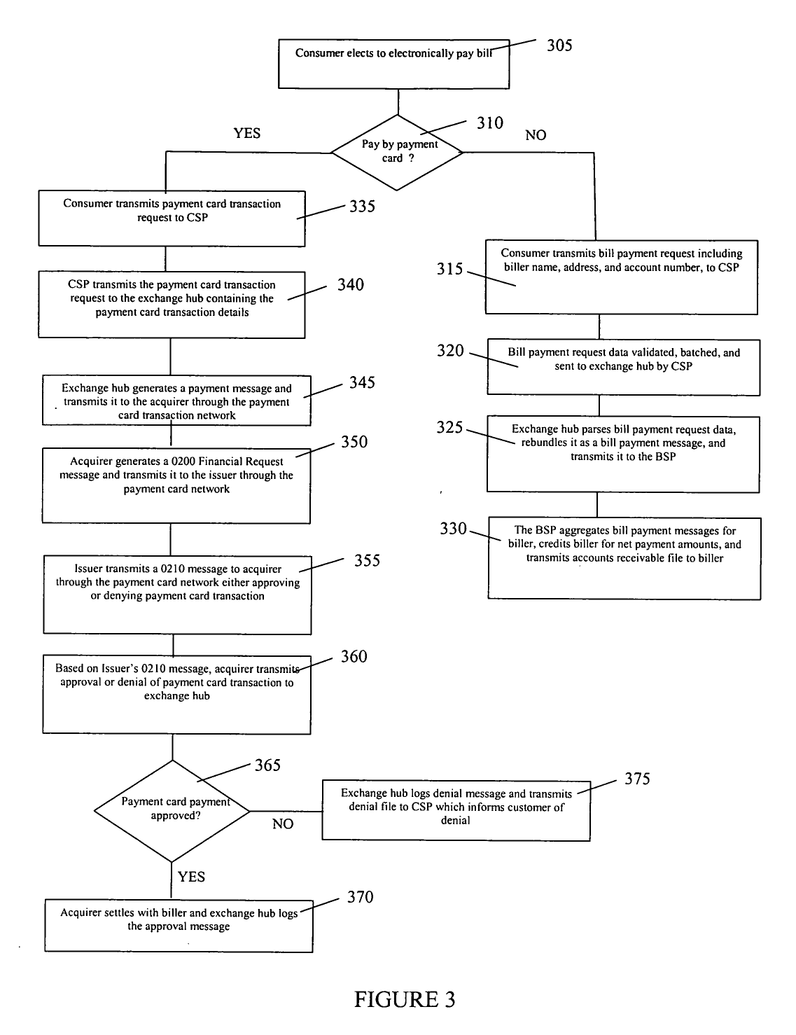

FIG. 2 is a block diagram depicting the components of an EBPP system 100 and payment card authorization system 160 in accordance with an exemplary embodiment of the present invention. FIG. 3 is a flow chart depicting the process by which the consumer 110a (FIG. 2) pays an electronic bill in the EBPP system 100 in accordance with an exemplary embodiment of the present invention. Referring to both FIG. 2 and FIG. 3, at step 305, a consumer 110a who has been presented with an electronic bill elects to pay the bill electronically using the EBPP system 100. At step 310, if the consumer 110a does not wish to pay the bill using a payment card, a bill payment request is transmitted at step 315 from the consumer 110a to the CSP 120. The bill payment request preferably includes the biller's 150a name, address, and account number, and a payment effective date.

At step 320, the CSP 120 validates the bill payment request, batches it, and transmits it to the exchange hub 130. At step 325, the exchange hub 130 parses the data in the batched bill payment request, and captures routing information from the bill payment request. The exchange hub 130 then rebundles the bill payment message, and delivers it to the intended recipient biller's 150a BSP 140. At step 330, the BSP 140 combines the bill payment messages it receives for the biller 150a, credits the biller 150a for net payment amounts, and finally prepares an accounts receivable file and transmits it to the biller 150a.

Referring again to step 310 (FIG. 3), if the consumer 110a elects to pay the bill electronically using a payment card, then at step 335 the consumer 110a transmits a payment card transaction request to the CSP 120. The payment card transaction request preferably contains all the information necessary to authorize the payment card transaction, such as card-holder name, payment card account number, and card expiration date. At step 340, the CSP 120 transmits the payment card transaction request as a pre-notification in their batch file to the exchange hub 130. All the details necessary for authorization processing are preferably contained in the IFX entry detail addendum record of the CSP's 120 message. At step 345, upon receiving the batch file from the CSP 120, the exchange hub 130 parses the payment card transaction request and generates a payment message to the biller's acquiring bank 160a (the “acquirer”) and transmits it to the acquirer 160a in the payment card authorization system 160.

From this point, the conventional process of payment card authorization is utilized, with the exchange hub 130 playing the same role that the merchant would play in a conventional credit card authorization process. At step 350, the acquirer 160a generates an 0200 Financial Request message, and transmits it to the payment card network 160b with a destination of the consumer's 110a payment card issuer 160c. The issuer 160c then, at step 355, receives the bill payment transaction for processing, and either approves or denies the transaction, after which the issuer 160c sends a 0210 response to the payment card network for routing back to the acquirer 160a. At step 360, the acquirer 160a receives the 0210 response from the issuer, and based on that response transmits a message to the exchange hub 130 either approving or denying payment. If at step 365 the payment card transaction was approved, the acquirer 160a settles with the biller 150a, and provides remittance data to the biller 150a. The exchange hub 130 logs at step 370 the approval message for historical purposes. The consumer 110a eventually pays the issuer 160c when he receives his payment card bill. If at step 365 the payment card transaction was denied, the exchange hub 130 logs at step 375 denial message and transmits a “denial” file to the CSP 120. The CSP 120 then notifies the consumer 110a of the denial.

Although the present invention has been described in connection with specific exemplary embodiments, it should be understood that various changes, substitutions and alterations can be made to the disclosed embodiments without departing from the spirit and scope of the invention as set forth in the appended claims.

What is claimed is:

1. A system for paying an electronic bill in an electronic bill payment and presentment (“EBPP”) system, the system comprising an exchange hub programmed to:
accept a payment card transaction request from a customer service provider (“CSP”);
submit the payment card transaction request to a payment card authorization system;
receive an approval message or a denial message from the payment card authorization system in response to the submission of the payment card transaction request; and
transmit the received approval or denial message to the CSP.

2. The system of claim 1, further comprising a customer service provider programmed to submit the payment card transaction request to the exchange hub in response to an electronic request from a consumer to pay the electronic bill with a payment card.

3. The system of claim 2 wherein the payment card is a credit card.

4. The system of claim 2 wherein the payment card is a debit card.

5. The system of claim 2 wherein the payment card is a pre-paid card.

6. A method for paying an electronic bill in an electronic bill payment and presentment (“EBPP”) system, comprising:
accepting at an exchange hub a payment card transaction request from a customer service provider (“CSP”);
submitting the payment card transaction request to a payment card authorization system;
receiving an approval message or a denial message from the payment card authorization system in response to the submission of the payment card transaction request; and
transmitting the received approval or denial message to the CSP.

7. The method of claim 6 further comprising:
accepting at the CSP an electronic request from a consumer to pay the electronic bill with a payment card; and
submitting the payment card transaction request to the exchange hub in response to the electronic request from the consumer to the CSP.

8. The method of claim 7 wherein the payment card is a credit card.

9. The method of claim 7 wherein the payment card is a debit card.

10. The method of claim 7 wherein the payment card is a pre-paid card.
